(19) United States
(12) Patent Application Publication
(10) Pub. No.: US 2007/0102550 A1
(43) Pub. Date: May 10, 2007

(54) Plastic grain cutting and transporting mechanism

(76) Inventor: Ping Ho Lin, Tainan County (TW)

Correspondence Address: Ping Ho Lin, No.2, Alley 492, Hai Tien Rd., Sec.2, Tainan City, TW

(21) Appl. No.: 11/267,910

(22) Filed: Nov. 7, 2005

(51) Int. Cl. B02C 18/18

(52) U.S. Cl. 241/277

(57) ABSTRACT

This mechanism employs an inlet support, which is located at the front side of the plastic grain-collector. A second plastic grain-collector is installed on the right side of the plastic grain-collector and the second plastic grain-collector is also a circular-tank-shaped container. The rotary cutter-holding base is located at the bottom of the collector, and there are three cutters held onto the rotary cutter-holding base. Three cutters for pulverization installed on the top of the cutter-holding base pulverize the plastic grains for the first time; the plastic grains are pulverized for the second time in the main plastic grain-collector. The cutting mechanism pulverizes the plastic grains with the help of the anti-gliding cutters at the inner wall of the plastic grain-collector, and by which it increases the performance of the pulverization. At last, by pushing the force induced from the rotation of the cutter-holding base, the plastic grains will move smoothly into the inlet. The main feature is that the raw materials processed initially in the second plastic grain-collector are pulverized thoroughly in the main plastic grain-collector. Since the performance of pulverization is improved, the better quality of the end product can be obtained.

### FIELD OF THE INVENTION

The present invention relates to a plastic grain cutting and transporting mechanism.

### BACKGROUND OF THE INVENTION

The prior plastic grain cutting and transporting mechanism, as FIGS. 1 and 2 shown, employs a plastic grain-collector 1, which is a circular-tank-shaped container, and a rotary cutter-holding base 9, which is located at the bottom of the collector 1 and is driven by motor 8. Three cutters 2 are installed on the rotary cutter holding base 9. With the help from the anti-gliding cutters 13 that are installed on the inner wall of the plastic grain-collector, the performance of pulverization is greatly improved. The force induced by rotation of the rotary cutter holding base 9 smoothly pushes plastic grains into the inlet 4. A pivot support 10 is installed at the left end of the inlet support 10 and is fastened onto the mounting base 11 of plastic grain-collector 1. A pivot hole, which is installed on the pivot support, acts as a supporting point for the left axle of screw conveyor 5, and makes the screw conveyor 5 stable during operation. A heating conduit 6, which is installed at the right side of the inlet support 3, heats up plastic grains. Meanwhile, the screw conveyor 5 that is connected to the outlet transports plastic grains.

But due to the defection of the prior mechanism design, the defects are described as the following:

First, the plastic grains in the main plastic grain-collector 14 need to be washed, therefore, most of the plastic grains contain moisture. As a result, the plastic grains can't be pulverized thoroughly only by the three cutters 2 and the anti-gliding cutters 3 and the moisture can't evaporate completely.

Second, since the moisture can't evaporate completely, the plastic grains heated to be sticky in the heating conduit still have moisture. As a result, the end products contain bubbles and miscellaneous quality. This will decrease the quality of the end quality.

Third, since the moisture can't evaporate completely, the heating conduit has to be prolonged to heat the plastic grains longer so that the moisture can evaporate completely. The whole process takes time, occupies space, and the high cost will be the result.

### BRIEF DESCRIPTION OF THE DRAWINGS

FIG. 1 shows an elevation cross-sectional view of the prior art,

FIG. 2 shows a front cross-sectional view of the prior art,

FIG. 3 shows an elevation cross-sectional view of the present invention, and

FIG. 4 shows a front cross-sectional view of the present invention.

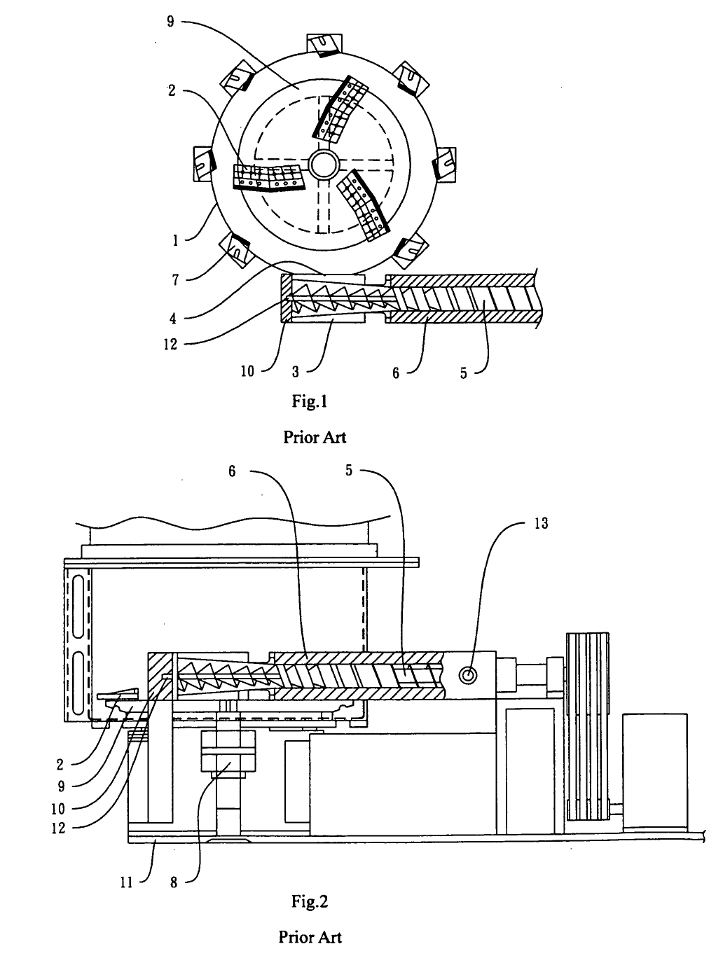

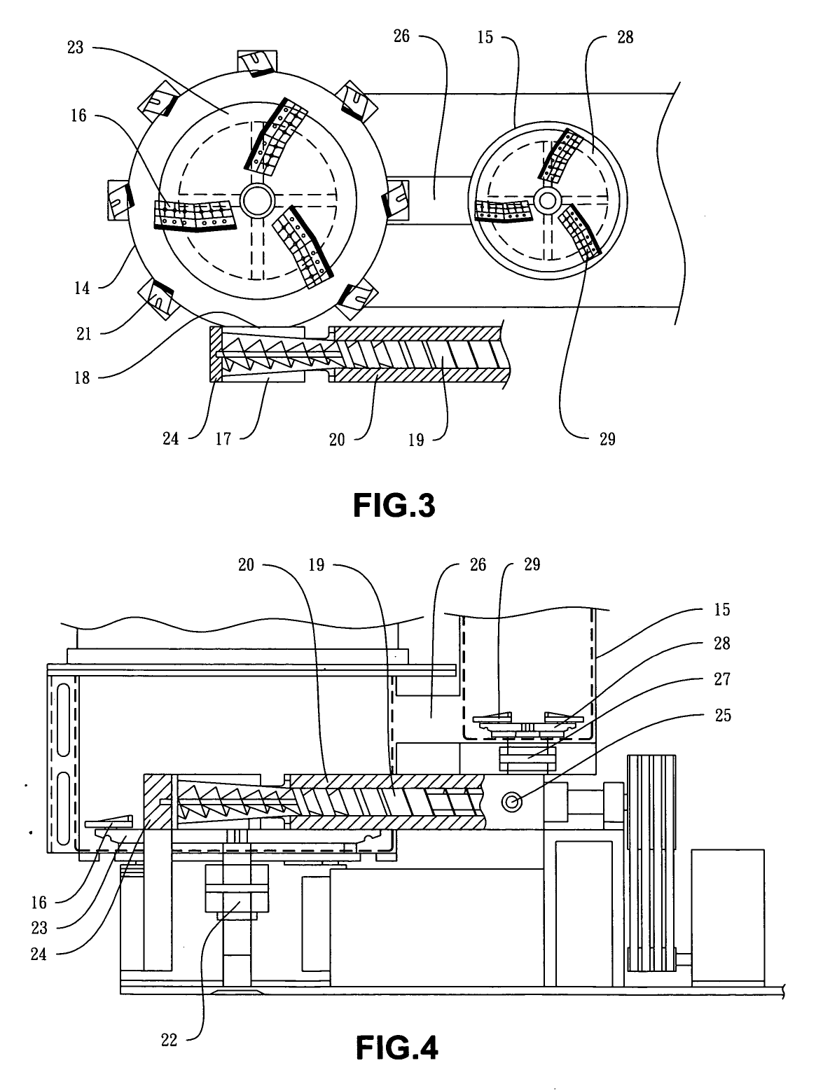

### DETAILED DESCRIPTION OF THE INVENTION

One inlet support 17 is installed on the front side of the plastic grain-collector 14. The inlet 18 is an opening located at the intersection between the inlet support 17 and the plastic grain-collector 14. The plastic grain-collector 14 is a circular-tank-shape container that has one rotary cutter-holding base 23, which is driven by one connected motor 22, installed at the bottom of the plastic grain-collector. Three cutters 16 for pulverization are installed on the top of the rotary cutter-holding base 23. With help from the anti-gliding cutters 21 that is installed on the inner wall of the plastic grain-collector 14, the performance of pulverization is greatly improved. The force induced by rotation of the rotary cutter-holding base 23 smoothly pushes plastic grains into the inlet 18. A pivot support 24 is installed at the left end of the inlet support 17 and is fastened onto the mounting base 11 of the plastic grain collector 14. A pivot hole, which is located on the pivot support, acts as a supporting point for the left axle end of screw conveyor 19, and makes the screw conveyor 19 stable during operation. A heating conduit 20, which is installed at the right side of the inlet support 12, heats up plastic grains. At the same time, the screw conveyor 19 that is connected to the outlet 25 transports plastic grains. The main feather is to install a tube on the right side of the main plastic grain-collector 14 connecting the second plastic grain-collector 15; the second plastic grain-collector 15 is also a circular-tank-shaped container that has one rotary cutter-holding base 28 driven by one connected motor 27. Three cutters 29 for pulverization installed on the top of the cutter-holding base pulverize the plastic grains for the first time, the plastic grains are pulverized for the second time in the main plastic grain-collector 14. The more the plastic grain-collector is, the better the cutting performance is, thus, the plastic grains are pulverized thoroughly and certainly, the quality of the end product is improved. The merit of this invention is described as the following:

First, the more the plastic grain-collector is, the better the cutting performance is. As a result, the thorough pulverization can be achieved and the moisture can be evaporated more completely. Certainly, the quality of the end product is improved

Second, since the moisture evaporates completely, the plastic grains are heated up in the heating conduit with less moisture. Moreover, the end product doesn't have any bubbles or miscellaneous quality, and certainly, the quality of the end product is improved.

Third, since the cutting performance is improved; the raw materials have less moisture. Thus, the heating conduit can be shortened half a length than the prior one. The moisture can be evaporated in the shorter heating conduit; therefore, the whole process is timesaving, economical and occupies less space.

1. One plastic grain cutting and transporting mechanism, employs a main plastic grain-collector, a second plastic grain-collector, an inlet support, connected motors, three cutters, anti-gliding cutters, a pivot support, screw conveyor and heat conduit. The main feature is the tube on the right side of the main plastic grain-collector connecting the second plastic grain-collector that has one rotary cutter-holding base driven by one connected motor. Three cutters installed on the top of the cutter-holding base pulverize the plastic grains for the first time, and then the plastic grains are pulverized for the second time in the main plastic grain-collector.

2. As described in claim 1, one plastic grain cutting and transporting mechanism wherein the plastic grains are pulverized for the first time in the second grain-collector and then pulverized for the second time in the main grain-collector. Thus, the plastic grains are pulverized thoroughly and certainly, and the quality of the end product is therefore improved.

3. As described in claim 1, one plastic grain cutting and transporting mechanism wherein the plastic grains are heated up in the heating conduit with less moisture. Thus the end product doesn't have any bobbles and miscellaneous quality.

4. As described in the claim 1, one plastic grain cutting and transporting mechanism with improved cutting performance and less moisture for the product, the heating conduit can be shortened half length than the prior one.
